(19) United States
(12) Patent Application Publication
(10) Pub. No.: US 2014/0373484 A1
(43) Pub. Date: Dec. 25, 2014

(54) Corona Treated Polyethylene Films

(71) Applicant: NOVA Chemicals (International) S.A., Fribourg (CH)

(72) Inventors: Owen C Lightbody, Calgary (CA); Tony Tikuisis, Calgary (CA); Norman Dorien Joseph Aubee, Okotoks (CA)

(73) Assignee: NOVA CHEMICALS (INTERNATIONAL) S.A., Fribourg (CH)

(21) Appl. No.: 14/306,798

(22) Filed: Jun. 17, 2014

(30) Foreign Application Priority Data
Jun. 25, 2013 (CA) 2819930

(51) Int. Cl. C08K 5/3492; B65B 61/00; B65B 51/10

(52) U.S. Cl. CPC C08K 5/3492; B65B 51/10; B65B 61/00
USPC 53/410

(57) ABSTRACT

A process for improving the sealing characteristics of corona treated polyolefin films through the use of a stabilizer system comprising i) 1,3,5-tris(4-tert-butyl-3-hydroxy-2,6-dimethyl benzyl)-1,3,5-triazine-2,4,6-(1H,3H,5H)-trione (CAS registry number 040601-76-1) and ii) an organic phosphite or phosphonite.

### FIELD OF THE DISCLOSURE

This disclosure relates to improving the sealing characteristics of polyolefin films that have been corona treated.

### BACKGROUND OF THE DISCLOSURE

Polyolefin films are widely used to prepare packaging. It is difficult to apply color printing to these films as the films are generally non polar and the printing inks are typically polar. There are several methods to improve ink adhesion, including the use of a primer coating; flame treatment of the surface and corona treatment.

Corona treatment is well known to those skilled in the art and is discussed for example, in U.S. Pat. No. 4,145,386 and in a paper by Lahti et al. entitled, “The Effects of Corona and Flame Treatment: Part 1: PE-LD Coated Packaging Board.” TAPPI, 2007 European PLACE Conference. In general, the corona treatment oxidizes the surface of the film. It is generally accepted that this surface oxidation causes the formation of polar functional groups on the film surface. In particular, hydroxyl, carbonyl, and carboxyl groups have been reported to be formed by corona treatment. While not wishing to be bound by theory, it is believed that those polar groups help to improve the adhesion of printing inks to the surface of the treated film.

However, corona treatment has also been observed to cause problems with the seal strength of treated films. While not wishing to be bound by theory, it is believed that corona treatment can cause crosslinking and/or chain scission on the film surface (and that, in turn, these crosslinking or chain scission phenomena can cause problems with seal formation and seal strength). We have now discovered that the use of a stabilizer system comprising i) 1,3,5-tris(4-tert-butyl-3-hydroxy-2,6-dimethyl benzyl)-1,3,5-triazine-2,4,6-(1H,3H,5H)-trione (CAS registry number 040601-76-1) and ii) a secondary antioxidant (a phosphite) mitigates this problem and provides a method to improve the sealing performance of corona treated polyethylene film.

### SUMMARY OF THE DISCLOSURE

The present disclosure provides a method for preparing a sealed polyethylene package having incorporated therein a stabilizer system sufficient to mitigate the deleterious effect of corona treatment on seal strength, said method comprising:
1) providing polyethylene film;
2) subjecting said polyethylene film to corona treatment;
3) forming a heat seal by subjecting two layers of said polyethylene film to a sealing bar at a temperature of from 120° C. to 220° C.;
   wherein said stabilizer system is characterized by comprising i) from 100 to 1000 parts per million by weight of 1,3,5-tris(4-tert-butyl-3-hydroxy-2,6-dimethyl benzyl)-1,3,5-triazine-2,4,6-(1H,3H,5H)-trione, and ii) from 100 to 1000 parts per million by weight of a secondary antioxidant selected from the group consisting of organic phosphites and phosphonites.

### DETAILED DESCRIPTION

The method disclosed is generally believed to be suitable for any thermoplastic polyolefin, polyethylene being a non-limiting example. The thermoplastic polyolefins are prepared with a transition metal catalyst such as titanium, vanadium, zirconium or chromium and the disclosed method is particularly suitable for polyolefins which contain from about 0.5 parts per million by weight (“ppm”) to about 15 parts per million by weight of transition metal residue. In addition, the polyolefin may contain magnesium residues (in amounts up to 500 ppm); aluminum residues (in amounts up to 150 ppm); and chlorine residues (in amounts up to 200 ppm).

It some cases the thermoplastic polyolefin is a linear polyethylene having:
(i) a density from about 0.88 grams per cubic centimeter (g/cc) to about 0.95 grams per cubic centimeter (g/cc) and in other cases from about 0.910 to about 0.945 g/cc; and
(ii) a melt index, 1₂, as determined by ASTM D 1238 from about 0.3 grams per 10 minutes (g/10 minutes) to about 20 g/10 minutes, in other cases, from about 1 to about 100 g/10 minutes and, in still other cases, from about 1.5 to about 5 g/10 minutes.

In other cases, the linear polyethylene are copolymers of ethylene with at least one other olefin; non-limiting examples of other olefins include butene, pentene, hexene and octene. These thermoplastic polyethylenes may be produced in any of the known polymerization processes; for example, a gas phase process, a slurry process or a solution process, using any known polymerization catalyst. Non-limiting examples of polymerization catalysts include chromium catalysts, Ziegler Natta catalysts or a single site catalysts such as a metallocene catalyst or a so-called “constrained geometry catalyst”.

The additive package of this disclosure contains a primary antioxidant (part A, below), a secondary antioxidant (a phosphite or phosphonite, Part B, below) and optionally, an acid neutralizer (described in part C.1 below). If the film described in this disclosure is intended for long term use, then the use of additional stabilizers (especially, HALS) is preferred as described in C.2 below. Other conventional additives may also be included.

### Part A: Primary Antioxidant

This disclosure requires the use of the trione additive described above (i.e. the molecule to which CAS registry number 040601-76-1 is assigned). This additive may be referred to as a primary antioxidant because it has the ability to scavenge free radicals. It is known to use this additive to stabilize polyolefins, but it is of higher cost than other primary antioxidants (and, hence, is in more limited use than other, less costly antioxidants).

Examples of more commonly used (less costly) primary antioxidants include the hindered phenols which have been assigned CAS registry numbers 6683-19-8 and 2082-79-3. While not wishing to be bound by theory, it is believed that the primary antioxidant used in this disclosure is less sterically encumbered (less hindered) than the more commonly used primary antioxidants and that, in turn, this allows the primary antioxidant in this disclosure to reduce the level of crosslinking that is caused by corona treatment. Ultimately, this disclosure provides corona treated polyethylene films having improved sealing characteristics and it is believed that the improvement in sealing characteristics may be associated with a lower level of crosslinking in the film.

The primary antioxidant disclosed, CAS Registry number 040601-76-1, in some cases is used in an amount of from about 100 to about 1000 parts per million by weight (ppm), based on the weight of the polyethylene; in other cases, the disclosed primary antioxidant is used in an amount from about 300 to about 500 ppm.

It is permissible to use the other primary antioxidants described in this section of this disclosure and doing so may help to lower costs (by allowing a lower amount of the more expensive antioxidant to be employed).

### Part B: Secondary Antioxidant: Organic Phosphites and Phosphinites

The stabilizer system used in this disclosure includes a secondary antioxidant, especially a phosphite. The phosphite may be an alkyl phosphite, an aryl phosphite or a diphosphite—all of which are in commercial use.

Suitable aryl monophosphites for use in this disclosure follow, trademarks are disclosed within square brackets.

Non-limiting examples of aryl monophosphites include: triphenyl phosphite; diphenyl alkyl phosphites; phenyl dialkyl phosphites; tris(nonylphenyl) phosphite [WESTON 399, available from GE Specialty Chemicals]; tris(2,4-di-tert-butylphenyl) phosphite [IRGAFOS 168, available from Ciba Specialty Chemicals Corp.]; bis(2,4-di-tert-butyl-6-methylphenyl) ethyl phosphite [IRGAFOS 38, available from Ciba Specialty Chemicals Corp.]; and 2,2′,2″-nitrilo[triethyltris(3,3′,5,5′-tetra-tert-butyl-1,1′-biphenyl-2,2′-diyl) phosphite [IRGAFOS 12, available from Ciba Specialty Chemicals Corp.].

Another suitable type of phosphite is a diphosphite. As used herein, the term diphosphite refers to a phosphite stabilizer which contains at least two phosphorus atoms per phosphite molecule.

Non-limiting examples of suitable diphosphites follow: distearyl pentaerythritol diphosphite, diisodecyl pentaerythritol diphosphite, bis(2,4-di-tert-butylphenyl) pentaerythritol diphosphite [ULTRANOX 626, available from GE Specialty Chemicals]; bis(2,6-di-tert-butyl-4-methylpenyl) pentaerythritol diphosphite; bisisodecyloxypentaerythritol diphosphite, bis(2,4-di-tert-butyl-6-methylphenyl) pentaerythritol diphosphite, bis(2,4,6-tri-tert-butylphenyl) pentaerythritol diphosphite, tetrakis(2,4-di-tert-butylphenyl)4,4′-bipheylene-diphosphonite [IRGAFOS P-EPQ, available from Ciba] and bis(2,4-dicumylphenyl)pentaerythritol diphosphite [DOVERPHOS S9228-T or DOVERPHOS S9228-CT].

Organic phosphonites may also be employed. A non-limiting example is tetrakis (2,4-di-t-butylphenyl)[1,1-biphenyl]-4,4′diylbisphosphonite (sold under the trademark PEP-Q). In some cases, the phosphite is used in an amount of from about 100 ppm to about 2,000 ppm; in other cases, from about 100 to about 1,000 ppm.

### Part C.1 Acid Neutralizers

Many commercially available polyolefins contain chloride residues. These chloride residues may generate hydrochloric acid, particularly during melt processing operations. Accordingly, an “acid neutralizer” is conventionally included in a polyolefin stabilization package; an additional embodiment of this disclosure includes a stabilizer system containing an acid neutralizer.

These acid neutralizers may be divided into “Inorganic”—such as zinc oxide, synthetic hydrotalcites and Li, Na, Ca or Al (hydroxy) carbonates; and “Organic”—such as salts of fatty acids or their derivatives including calcium stearate, zinc stearate, calcium lactate and calcium stearoyl lactylate.

When employed, these conventional acid neutralizers are used in conventional amounts. In some cases, a synthetic hydrotalcite may be used in an amount from about 100 to about 2000 ppm, a zinc stearate may be used in an amount of from about 200 to about 700 ppm, or a calcium stearoyl lactylate may be used in an amount from about 200 to about 700 ppm. In other cases, a combination of a hydrotalcite with an “organic” acid neutralizer may be used.

### Part C.2 Long Term Stabilizers

Plastic parts which are intended for long term use may contain at least one HALS (C.2.1).

### Part C.2.1 HALS

A hindered amine light stabilizer (HALS) is, in some cases, included in the stabilizer package of this disclosure if the plastic part is intended for more than single/short term use.

HALS are well known to those skilled in the art.

When employed, commercially available HALS are suitable and may be used in the conventional manner and amount.

Non-limiting examples of commercially available HALS include those sold under the trademarks CHIMASSORB 119; CHIMASSORB 944; CHIMASSORB 2020; TINUVIN 622 and TINUVIN 770 from Ciba Specialty Chemicals Corporation, and CYASORB UV 3346, CYASORB UV 3529, CYASORB UV 4801, and CYASORB UV 4802 from Cytec Industries. Mixtures of more than one HALS are also contemplated.

Additional non-limiting examples of suitable HALS include: bis (2,2,6,6-tetramethylpiperidyl)-sebacate; bis-5(1,2,2,6,6-pentamethylpiperidyl)-sebacate; n-butyl-3,5-di-tert-butyl-4-hydroxybenzyl malonic acid bis(1,2,2,6,6,-pentamethylpiperidyl)ester; condensation product of 1-hydroxyethyl-2,2,6,6-tetramethyl-4-hydroxy-piperidine and succinic acid; condensation product of N,N′-(2,2,6,6-tetramethylpiperidyl)-hexamethylenediamine and 4-tert-octylamino-2,6-dichloro-1,3,5-s-triazine; tris-(2,2,6,6-tetramethylpiperidyl)-nitrilotriacetate; tetrakis-(2,2,6,6-tetramethyl-4-piperidyl)-1,2,3,4-butane-tetra-arbonic acid; and 1,1′(1,2-ethanediyl)-bis-(3,3,5,5-tetramethylpiperazinone).

### Part C.2.2 Other Optional Additives

C.2.2.1 2-(2′-hydroxyphenyl)-benzotriazoles

For example, the 5′-methyl-; 3′5′-di-tert-butyl-; 5′-tert-butyl-; 5′(1,1,3,3-tetramethylbutyl)-; 5-chloro-3′,5′-di-tert-butyl-; 5-chloro-3′-tert-butyl-5′-methyl-; 3′-sec-butyl-5′-tert-butyl-; 4′-octoxy; 3′,5′-ditert-amyl- or 3′,5′-bis-(alpha,alpha-dimethylbenzyl)-derivatives.

### C.2.2.2 2-Hydroxy-Benzophenones

For example, the 4-hydroxy-; 4-methoxy-; 4-octoxy-; 4-decyloxy-; 4-dodecyloxy-; 4-benzyloxy-; 4,2′,4′-trihydroxy- or 2′-hydroxy-4,4′-dimethoxy derivative.

### C.2.2.3 Esters of Substituted and Unsubstituted Benzoic Acids

For example, phenyl salicylate; 4-tertbutylphenyl-salicilate; octylphenyl salicylate; dibenzoylresorcinol; bis-(4-tert-butylbenzoyl)-resorcinol; benzoylresorcinol; 2,4-di-tert-butyl-phenyl-3,5-di-tert-butyl-4-hydroxybenzoate; and hexadecyl-3,5-di-tert-butyl-4-hydroxybenzoate.

### C.2.2.4 Acrylates

For example, alpha-cyano-.beta.beta.-diphenylacrylic acid-ethyl ester or isooctyl ester; alpha-carbomethoxy-cinnamic acid methyl ester; alpha-cyano-.beta.-methyl-p-methoxy-cinnamic acid methyl ester or butyl ester; alpha-carbomethoxy-p-methoxy-cinnamic acid methyl ester; and N-(beta-carbomethoxy-beta-cyano-vinyl)-2-methyl-indoline.

### C.2.2.5 Nickel Compounds

For example, nickel complexes of 2,2′-thio-bis(4-(1,1,1,3-tetramethylbutyl)-phenol), such as, the 1:1 or 1:2 complex, optionally with additional ligands such as n-butylamine, triethanolamine or N-cyclohexyl-diethanolamine; nickel dibutyldithiocarbamate; nickel salts of 4-hydroxy-3,5-di-tert-butylbenzylphosphonic acid monoalkyl esters, such as, of the methyl, ethyl, or butyl ester; nickel complexes of ketoximes, such as, of 2-hydroxy-4-methyl-penyl undecyl ketoxime; and nickel complexes of 1-phenyl-4-lauroyl-5-hydroxy-pyrazole, optionally with additional ligands.

### C.2.2.6 Oxalic Acid Diamides

For example, 4,4′-di-octyloxy-oxanilide; 2,2′-di-octyloxy-5′,5′-ditert-butyloxanilide; 2,2′-di-dodecyloxy-5′,5′di-tert-butyl-oxanilide; 2-ethoxy-2′-ethyl-oxanilide; N,N′-bis(3-dimethylaminopropyl)-oxalamide; 2-ethoxy-5-tert-butyl-2′-ethyloxanilide and its mixture with 2-ethoxy-2′-ethyl-5,4-di-tert-butyloxanilide; and mixtures of ortho- and para-methoxy as well as of o- and p-ethoxy-disubstituted oxanilides.

### C.2.2.7 Hydroxyphenyl-s-triazines

For example, 2,6-bis-(2,4-dimethylphenyl)-4-(2-hydroxy-4-octyloxyphenyl)-s-triazine; 2,6-bis(2,4-dimethylphenyl)-4-(2,4-dihydroxyphenyl)-s-triazine; 2,4-bis(2,4-dihydroxyphenyl)-6-(4-chlorophenyl)-s-triazine; 2,4-bis(2-hydroxy-4-(2-hydroxyethoxy)phenyl)-6-(4-chlorophenyl)-s-triazine; 2,4-bis(2-hydroxy-4-(2-hydroxyethoxy)phenyl)-6-phenyl-s-triazine; 2,4-bis(2-hydroxy-4-(2-hydroxyethoxy)-phenyl)-6-(2,4-dimethylphenyl)-s-triazine; 2,4-bis(2-hydroxy-4-(2-hydroxyethoxy)phenyl)-6-(4-bromo-phenyl)-s-triazine; 2,4-bis(2-hydroxy-4-(2-acetoryethoxy)phenyl)-6-(4-chlorophenyl)-s-triazine; and 2,4-bis(2,4-dihydroxyphenyl)-6-(2,4-dimethylphenyl)-1-s-triazine.

### C.2.2.8 Metal Deactivators

For example, N,N′diphenyloxalic acid diamide; N-salicylal-N′-salicyloylhydrazine; N,N′-bis-salicyloylhydrazine, N,N′-bis-(3,5-di-tert-butyl-4-hydrophenylpropionyl)-2-hydrazine; salicyloylamino-1,2,4-triazole; and bis-benzyliden-oxalic acid dihydrazide.

### C.2.2.9 Peroxide Scavengers

For example, esters of betathiodipropionic acid, for example, the lauryl, stearyl, myristyl or tridecyl esters; mercaptobenzimidazole or the zinc salt of 2-mercaptobenzimidazole; zinc-dibutyldithiocarbamate; dioctadecyldisulfide; and pentaerythritottetrakis-(beta-dodecylmercapto)-propionate.

### C.2.2.10 Polyamide Stabilizers

For example, copper salts in combination with iodides and/or phosphorus compounds and salts of divalent manganese.

### C.2.2.11. Nucleating Agents

For example, 4-tert-butylbenzoic acid; adipic acid; diphenylacetic acid; sodium salt of methylene bis-2,4-dibutylphenyl; cyclic phosphate esters; sorbitol tris-benzaldehyde acetal; and sodium salt of bis(2,4-di-t-butylphenyl) phosphate or Na salt of ethylidene bis(2,4-di-t-butyl phenyl)phosphate.

### C.2.2.12. Fillers and Reinforcing Agents

For example, calcium carbonate; silicates; glass fibers; asbestos; talc; kaolin; mica; barium sulfate; metal oxides and hydroxides; carbon black and graphite.

### C.2.2.13 Hydroxylamines and Amine Oxides

For example, N,N-dibenzylhydroxylamine; N,N-diethylhydroxylamine; N,N-dioctylhydroxylamine; N,N-dilaurylhydroxylamine; N,N-ditetradecylhydroxylamine; N,N-dihexadecylhydroxylamine; N,N-dioctadecylhydroxylamine; N-hexadecyl-N-octadecylhydroxylamine; N-heptadecyl-N-octadecylhydroxylamine; and N,N-dialkylhydroxylamine derived from hydrogenated tallow amine.

### C.2.2.14 Lactones

The use of lactones such as benzofuranone (and derivatives thereof) or indolinone (and derivatives thereof) as stabilizers as described in U.S. Pat. No. 4,611,016.

### C.2.2.15. Miscellaneous Additives

For example, plasticizers; epoxidized vegetable oils, such as epoxidized soybean oils; lubricants; emulsifiers; polymer process additives (e.g., fluoroelastomers); pigments; optical brighteners; flameproofing agents; anti-static agents; blowing agents and thiosynergists, such as dilaurythiodipropionate or distearylthiodipropionate.

### Part D.1 Other Phenolic Antioxidants

### D.1.1 Alkylated Mono-Phenols

For example, 2,6-di-tert-butyl-4-methylphenol; 2-tert-butyl-4,6-dimethylphenol; 2,6-di-tert-butyl-4-ethylphenol; 2,6-di-tert-butyl-4-n-butylphenol; 2,6-di-tert-butyl-4-isobutylphenol; 2,6-dicyclopentyl-4-methylphenol; 2-(.alpha.-methylcyclohexyl)-4,6-dimethylphenol; 2,6-di-octadecyl-4-methylphenol; 2,4,6,-tricyclohexyphenol; and 2,6-di-tert-butyl-4-methoxymethylphenol.

### D.1.2 Alkylated Hydroquinones

For example, 2,6-di-tert-butyl-4-methoxyphenol; 2,5-di-tert-butylhydroquinone; 2,5-di-tert-amyl-hydroquinone; and 2,6-diphenyl-4-octadecyloxyphenol.

### D.1.3 Hydroxylated Thiodiphenyl Ethers

For example, 2,2′-thio-bis-(6-tert-butyl-4-methylphenol); 2,2′-thio-bis-(4-octylphenol); 4,4′-thio-bis-(6-tertbutyl-3-methylphenol); and 4,4′-thio-bis-(6-tert-butyl-2-methylphenol).

### D.1.4 Alkylidene-Bisphenols

For example, 2,2′-methylene-bis-(6-tert-butyl-4-methylphenol); 2,2′-methylene-bis-(6-tert-butyl-4-ethylphenol); 2,2′-methylene-bis-(4-methyl-6-(alpha-methylcyclohexyl)phenol); 2,2′-methylene-bis-(4-methyl-6-cyclohexylphenol); 2,2′-methylene-bis-(6-nonyl-4-methylphenol); 2,2′-methylene-bis-(6-nonyl-4-methylphenol); 2,2′-methylene-bis-(6-(alpha-methylbenzyl)-4-nonylphenol); 2,2′-methylene-bis-(6-(alpha,alpha-dimethylbenzyl)-4-nonyl-phenol); 2,2′-methylene-bis-(4,6-di-tert-butylphenol); 2,2′-ethylidene-bis-(6-tert-butyl-4-isobutylphenol); 4,4′methylene-bis-(2,6-di-tert-butylphenol); 4,4′-methylene-bis-(6-tert-butyl-2-methylphenol); 1,1-bis-(5-tert-butyl-4-hydroxy-2-methylphenol)butane; 2,6-di-(3-tert-butyl-5-methyl-2-hydroxybenzyl)-4-methylphenol; 1,1,3-tris-(5-tert-butyl-4-hydroxy-2-methylphenyl)butane; 1,1-bis-(5-tert-butyl-4-hydroxy-2-methylphenyl)-3-dodecyl-mercaptobutane; ethyleneglycol-bis-(3,3,-bis-(3′-tert-butyl-4′-hydroxyphenyl)-butyrate)-di-(3-tert-butyl-4-hydroxy-5-methylpenyl)-dicyclopentadiene; di-(2-(3′-tert-butyl-2′-hydroxy-5′-methylbenzyl)-6-tert-butyl-4-methylphenyl)terephthalate; and other phenolics such as monoacrylate esters of bisphenols, such as, ethylidiene bis-2,4-di-t-butylphenol monoacrylate ester.

### D.1.5 Benzyl Compounds

For example, 1,3,5-tris-(3,5-di-tert-butyl-4-hydroxybenzyl)-2,4,6-trimethylbenzene; bis-(3,5-di-tert-butyl-4-hydroxybenzyl)sulfide; isooctyl-3,5-di-tert-butyl-4-hydroxybenzyl-mercaptoacetate; bis-(4-tert-butyl-3-hydroxy-2,6-dimethylbenzyl)dithiol-terephthalate; 1,3,5-tris-(3,5-di-tert-butyl-4,10-hydroxybenzyl)isocyanurate; 1,3,5-tris-(4-tert-butyl-3-hydroxy-2,6-dimethylbenzyl)isocyanurate; dioctadecyl 3,5-di-tert-butyl-4-hydroxybenzylphosphonate; calcium salt of monoethyl 3,5-di-tertbutyl-4-hydroxybenzylphosphonate; and 1,3,5-tris-(3,5-dicyclohexyl-4-hydroxybenzyl)isocyanurate.

### D.1.6 Acylaminophenols

For example, 4-hydroxy-lauric acid anilide; 4-hydroxy-stearic acid anilide; 2,4-bis-octylmercapto-6-(3,5-tert-butyl-4-hydroxyanilino)-s-triazine; and octyl-N-(3,5-di-tert-butyl-4-hydroxyphenyl)-carbamate.

D.1.7 Esters of beta-(5-tert-butyl-4-hydroxy-3-methylphenyl)-propionic acid with monohydric or polyhydric alcohols

For example, methanol; diethyleneglycol; octadecanol; triethyleneglycol; 1,6-hexanediol; pentaerythritol; neopentylglycol; tris-hydroxyethyl isocyanurate; thiodiethyleneglycol; and dihydroxyethyl oxalic acid diamide.

D.1.8 Amides of beta-(3,5-di-tert-butyl-4-hydroxyphenol)-propionic acid

For example, N,N′-di-(3,5-di-tert-butyl-4-hydroxyphenylpropionyl)-hexamethylendiamine; N,N′-di-(3,5-di-tert-butyl-4-hydroxyphenylpropionyl)trimethylenediamine; and N,N′-di(3,5-di-tert-butyl-4-hydroxyphenylpropionyl)-hydrazine.

### Polyethylene Film

In this disclosure a conventional polyethylene film is prepared; for example a “blown” film or a “cast” film.

In a blown film process, the polyethylene is melted in a screw extruder (preferably at a temperature of from 200° C. to 290° C., especially from 210° C. to 250° C.) and then forced through an annuler die to form a tube of molten polyethylene. The tube is inflated with air from the interior of the tube, then cooled and finally flattened by nip rolls. It is also known to co-extrude multi layers of film by this process.

In a cast film process, the polyethylene is also melted in a screw extruder (preferably at temperatures of from 450° F. (232° C.) to 600° F. (316° C.) especially from 500° F. (260° C.) to 550° F. (288° C.) and then forced through a flat die. The molten polyethylene web is then cooled (typically, through the use of a water bath or, alternatively, temperature controlled casting rolls).

The present invention will further be described by reference to the following examples. The following examples are merely illustrative of the invention and are not intended to be limiting. Unless otherwise indicated, all percentages are by weight.

### EXAMPLE

Blown films having a thickness of about 2 mils were prepared on a conventional blown film line sold by Gloucester Engineering. The resin used for all experiments in this disclosure was a linear low density polyethylene having a melt index (I₂) of 1 g/10 minutes and a density of 0.920 g/cm³. More specifically, the resin was an ethylene-octene copolymer, produced in a solution polymerization process with a titanium catalyst and it contained residual titanium in an amount estimated at 9±2 ppm (based on typical values).

The blown film line was operated at a rate of about 55 kilograms of extruded polyethylene per hour. The polyethylene was extruded through an annular die having a gap of 35 mils.

The blown film line was equipped with a commercially available corona treatment unit (sold by Sherman Treaters Inc.). In general, a wetting tension of at least about 35 dynes/cm is used for commercial films, in other cases, a wetting tension from about 35 to about 50 dynes/cm is used. The corona treatment apparatus was adjusted so as to provide a wetting surface tension of 44 dynes/cm (as determined by ASTM D2578) for the films of this example.

All films were allowed to “condition” for 48 hours prior to sealing. After the conditioning period, 1 inch wide film strips were sealed (treated side to treated side) over a temperature range of 140° C. to 180° C. using a two bar sealing system sold by Sencorp Inc. Heat was applied only to the upper seal bar. The sealing pressure was 15 pounds per square inch (psi) and the dwell time was 0.5 seconds. Once the seals were made, they were allowed to sit for 24 hours before being tested. The cold seal strength of these samples was determined using a 5-head universal tester according to ASTM F88 with a 2 inch grip separation and a test speed of 20 inches/min.

Data are compiled in Table 1 as “Seal Strength (Newtons)”. The data correspond to the break load (or seal strength)—in Newtons—as determined by ASTM F88. For example/clarity: a force of 18.9 Newtons was required to break the inventive seal that was formed at 180° C. (as shown in Table 1).

Comparative films were prepared with a conventional antioxidant package containing 500 ppm of a hindered phenolic (sold under the trademark IRGANOX 1076) and 500 ppm of a phosphite (sold under the trademark IRGAFOS 168). These films exhibited very poor sealing behavior after being corona treated (at a level sufficient to provide 44 dynes/cm of surface tension). The sealing data for these comparative film are not shown in Table 1.

Another set of films were prepared with an additive package containing 750 ppm of IRGAFOS 168 and 500 ppm of a diphosphite sold under the trademark DOVERFOS 9228; hereafter, this additive package will be referred to as “comparative formulation 1”. The sealing properties of these films are shown in Table 1, i.e., in the column titled “Comparative Formulation 1”. As shown in Table 1, comparative formulation 1 provided weak seals at sealing temperatures from 170° C. to 180° C. For clarity, comparative formulation 1 provided a seal strength of 1.1 Newtons at a sealing temperature of 160° C. and a seal strength of 3.0 Newtons at 180° C.

One embodiment of an inventive film was prepared by adding a further 500 ppm of 1,3,5-tris(4-tert-butyl-3-hydroxy-2,6-dimethyl benzyl)-1,3,5-triazine-2,4,6-(1H,3H,5H)-trione (CAS registry number 040601-76-1) to comparative formulation 1. As shown in Table 1 (under the column “Inventive Formulation 1”) these films exhibited higher sealing strengths (up to 18.9 Newtons at a sealing temperature of 180° C.) across a broader sealing window.

TABLE 1
Film seal strength (films were corona treated to
about 44 dynes/cm).

| | Comparative | Inventive |
|---|---|---|
| Sealing | Formulation 1 | Formulation 1 |
| Temperature | (Newtons) | (Newtons) |
| 140° C. | 0.1 | 2.6 |
| 145° C. | 0.5 | 6.8 |
| 150° C. | 0.8 | 13.8 |
| 160° C. | 1.1 | 15.0 |
| 170° C. | 2.8 | 16.4 |
| 180° C. | 3.0 | 18.9 |

The present invention has been described with reference to specific details of particular embodiments thereof. It is not intended that such details be regarded as limitations upon the scope of the invention except insofar as and to the extent that they are included in the accompanying claims.

What is claimed is:

1. A method for preparing a sealed polyethylene package having incorporated therein a stabilizer system sufficient to mitigate the deleterious effect of corona treatment on seal strength, said method comprising:
1) providing polyethylene film;
2) subjecting said polyethylene film to corona treatment;
3) forming a heat seal by subjecting two layers of said polyethylene film to a sealing bar at a temperature of from about 120° C. to about 220° C.;
wherein said stabilizer system is characterized by comprising i) from about 100 parts per million by weight to about 1000 parts per million by weight of 1,3,5-tris(4-tert-butyl-3-hydroxy-2,6-dimethyl benzyl)-1,3,5-triazine-2,4,6-(1H,3H,5H)-trione, and ii) from about 100 parts per million by weight to about 1000 parts per million by weight of a secondary antioxidant selected from the group consisting of organic phosphites and phosphonites.

2. The method of claim 1 wherein said polyethylene is a linear low density polyethylene.

3. The method of claim 2 wherein said linear low density polyethylene is a copolymer of ethylene with at least one olefin selected from the group consisting of butene, hexene, and octene.

4. The method of claim 3 wherein said linear low density polyethylene has a density of from about 0.88 grams per cubic centimeter to about 0.95 grams per cubic centimeter and a melt index, I₂, as determined by ASTM D1238 of from about 0.3 grams/10 minutes to about 20 grams/10 minutes.

5. The method of claim 1 wherein said corona treatment is sufficient to provide a wetting tension of from about 35 dyne/cm to about 50 dyne/cm.

6. The method of claim 1 wherein said stabilizer system further comprises from about 100 parts per million by weight to about 1000 parts per million by weight of a primary antioxidant different from 1,3,5-tris(4-tert-butyl-3-hydroxy-2,6-dimethyl benzyl)-1,3,5-triazine-2,4,6-(1H,3H,5H)-trione.
